(19) United States
(12) Patent Application Publication
(10) Pub. No.: US 2022/0333970 A1
(43) Pub. Date: Oct. 20, 2022

(54) Ultrasonic Transducer and Method of Operating an Ultrasonic Transducer

(71) Applicant: TDK Electronics AG, Munich (DE)

(72) Inventors: Mikel Gorostiaga Altuna, Graz (AT); Peter Lukan, Deutschlandsberg (AT)

(21) Appl. No.: 17/639,259

(22) PCT Filed: May 26, 2021
(86) PCT No.: PCT/EP2021/064058

§ 371 Date: Feb. 28, 2022

(30) Foreign Application Priority Data
Jun. 3, 2020 (DE) 102020114777.5

(51) Int. Cl. G01F 23/296

(52) U.S. Cl. CPC G01F 23/2966

(57) ABSTRACT

In an embodiment an ultrasonic transducer includes an ultrasonic unit with a housing in which a piezoelectric element is located, wherein the ultrasonic unit includes at least one electrical connecting lead leading out of the housing, the connecting lead being configured for connection to control and/or evaluation electronics arranged separately from the ultrasonic unit, and wherein the ultrasonic unit is configured to operate in a thickness oscillation mode.

This patent application is a national phase filing under section 371 of PCT/EP2021/064058, filed May 26, 2021, which claims the priority of German patent application 102020114777.5, filed Jun. 3, 2020, each of which is incorporated herein by reference in its entirety.

### TECHNICAL FIELD

The present invention relates to an ultrasonic transducer which is configured, for example, to measure a fill level of a liquid in a container.

### BACKGROUND

The measurement of the fill level, and thus the determination of the residual amount of liquid in the container, is important for a variety of fields. Examples include household boilers filled with hot water, containers in breweries, gas cylinders, water cisterns in agricultural operations, or containers containing chemicals in the industrial sector.

Some of such containers already contain an integrated level gauge. In the case of containers without an integrated level gauge, in the simplest case the container is opened and the fill level is determined by sighting or by inserting a rod. However, this is often inaccurate and time-consuming. In addition, real-time monitoring of the fill level is not possible in this way, and it cannot be used with toxic and contamination-sensitive liquids. Likewise, such a method is not possible for pressurized vessels.

With an ultrasonic transducer it is possible to measure the fill level without contact with the liquid and in real time. The documents DE 102015113908 A1 and US 2012163126 A1 describe such ultrasonic transducers.

For example, an ultrasonic transducer can be arranged on the outside of a container. In this case, an electrical signal is converted into an acoustic signal by the ultrasonic transducer. The acoustic signal is sent, for example, through a gas above the liquid level in the direction of the liquid, or from below through the liquid in the direction of the gas. A reflection of the signal then occurs at the interface of the media due to the difference in acoustic impedance. The reflected signal component then travels back to the ultrasonic transducer and is converted into an electrical signal. The level can be determined from the transit time of the acoustic signal and the acoustic velocity in the fluid.

### SUMMARY OF THE INVENTION

Embodiments provide an improved ultrasonic transducer and a method for operating an ultrasonic transducer.

According to a first embodiment of the present invention, an ultrasonic transducer comprises an ultrasonic unit comprising a piezoelectric element arranged in a housing. The ultrasonic transducer further comprises one or more connecting leads for electrically connecting the piezoelectric element, the connecting leads being led out of the housing.

The connecting leads are configured for connection to control and/or evaluation electronics provided separately from the ultrasonic unit. This may be a compact electronics unit, for example.

By separating the ultrasonic unit and the electronics, the size of the ultrasonic unit can be minimized. Thus, the ultrasonic unit can also be arranged in a confined space. In addition, the electronics can be placed in a location that is easily accessible to a user.

For example, the ultrasonic unit is used to measure the fill level of a container filled with liquid. The ultrasonic unit can also be used for other purposes, in particular for generating and receiving acoustic signals in liquids and also in solids, for example for measuring distances. In particular, the ultrasonic unit is configured for emitting and/or receiving ultrasonic waves in a frequency range of a few MHz.

The ultrasonic unit is configured, for example, for arrangement on an underside of the container. The electronics are configured, for example, for arrangement on a side surface of the container. The ultrasonic unit can also be arranged inside the container, for example in the liquid.

The connecting lead is formed, for example, in the form of a coaxial cable or a flexible conductor tape.

The piezoelectric element may be fastened to a cover plate of the housing. The cover plate is, for example, a steel plate. The cover plate may also be formed of another material. To avoid reflections of the generated acoustic signal at the interface to the cover plate, it is advantageous if the acoustic impedance of the cover plate is as close as possible to the acoustic impedance of the piezoelectric element.

The ultrasonic unit is configured to operate in a thickness oscillation mode, in particular a thickness resonance mode. In this case, the geometry of the piezoelectric element and the cover plate is selected such that the acoustic vibration of the piezoelectric element in the thickness direction, i.e., in a direction parallel to the propagation direction of the generated acoustic signal and thus perpendicular to the main surfaces of the piezoelectric element and the cover plate can be efficiently utilized in operation. The acoustic vibration is conducted to the outside, for example into the liquid, via the cover plate. The cover plate is thus configured to transmit the acoustic vibration to the outside as unchanged as possible. In particular, the acoustic vibration is transmitted from the piezoelectric element via the cover plate into the fluid in the form of a plane wave.

In particular, the overall thickness of the piezoelectric element and the cover plate may be selected such that a resonant thickness vibration at a desired operating frequency is provided. In particular, it may be in a form of a half-wave resonance.

For example, a suitable operating frequency of the ultrasonic transducer with respect to the acoustic signal to be generated is in the range of a few MHz or slightly below 1 MHz for an application as a fill level gauge. In particular, the ultrasonic transducer may be configured for operation at a frequency of 500 kHz to 3 MHz. The geometry of the piezoelectric element and the cover plate is then selected accordingly.

Such operation enables a significant miniaturization of the ultrasonic unit compared to the design for operation at a length resonance frequency of the piezoelectric element.

However, since the cover plate has no piezoelectrically active material and thus does not contribute to the piezoelectric transmission and reception characteristics, the thickness of the cover plate should be as small as possible. This is possible because the main function of the cover plate is to protect and support the piezoelectric element. The cover plate should have as little effect as possible on the properties of the ultrasonic transducer and, for example, only play a role in fine-tuning the resonant frequency.

In particular, the thickness of the piezoelectric element is greater than the thickness of the cover plate. The ratio of the thickness of the piezoelectric element to the thickness of the cover plate is, for example, at least 5:1 or more. The thickness of the cover plate may be minimized to the extent necessary to provide the required robustness of the cover plate as a component of the housing. For example, the cover plate has a thickness of 200 μm or less.

The thickness of the cover plate can be used to fine tune the thickness vibration resonance of the overall system of piezoelectric element and cover plate in. In this case, the ultrasonic transducer is used with optimum efficiency. For example, a desired operating frequency is specified for fine tuning and a piezoelectric element with an approximately matching thickness is selected. The thickness of the cover plate can then be varied until a thickness vibration of the system of piezoelectric element and cover plate in resonance is obtained at the selected operating frequency.

The ultrasonic unit can be configured to be very small. For example, the ultrasonic unit has a thickness of at most 5 mm and a diameter of at most 5 cm. In particular, the ultrasonic unit may have a thickness of at most 2 mm and a diameter of at most 40 mm. The ultrasonic unit may have the geometry and size of a small disk, such as a coin. For example, the ultrasonic unit has an overall thickness that is at most three times the thickness of the piezoelectric element. In particular, the overall thickness of the ultrasonic unit may be at most two times the thickness of the piezoelectric element.

A further embodiment of the present invention relates to a use of the ultrasonic transducer described in the foregoing. The ultrasonic transducer is configured, for example, for use in measuring a fill level of a liquid in a container. The container is, for example, commercially available large volume containers, for example having a volume of several hundred liters to several thousand liters.

The ultrasonic unit can be manufactured at low cost, so that it is also suitable as a mass-produced article for equipping many containers.

A further embodiment of the present invention relates to an arrangement of the ultrasonic transducer described in the foregoing, in particular when used for measuring the level of a container. In this regard, the ultrasonic unit may be arranged on an underside of the container, for example a large volume container.

The connecting lead can be led from the underside to the outside and connected there to an electronic unit, in particular a compact electronic unit. For example, an electronics unit is attached to a side surface of the container.

The ultrasonic unit may be fastened to the container by bonding, for example by using an adhesive with suitable acoustic impedance, or using an adhesive tape. It is also possible that the ultrasonic unit is fixed in position only by the weight of the container. This fixation is particularly suitable for smaller containers, which only exert a small amount of weight on the ultrasonic unit. With such an arrangement, the container can be quickly replaced without having to re-mount the ultrasonic unit.

With such a fixation, the ultrasonic unit can be easily replaced if damaged or lost. In particular, no complex mounting on the container is necessary. In this case, the container also does not have to provide a receiving device for the ultrasonic unit.

A further embodiment of the present invention relates to a method of operating the ultrasonic transducer described in the foregoing. The ultrasonic transducer is thereby operated in a thickness vibration mode, in particular at a thickness resonance frequency. For example, the ultrasonic transducer is operated in this case at a frequency of 500 kHz to 3 MHz. This frequency range is particularly suitable for acoustic waves that are to propagate in a liquid. For example, the ultrasonic transducer is used in the method for measuring the fill level of a container.

A further embodiment of the present invention relates to a method for manufacturing an ultrasonic unit, in particular for fine tuning an ultrasonic unit. This may be the ultrasonic unit described in the foregoing. Here, the electronic unit may also not be formed separately. According to the method, a desired operating frequency, for example in a range of 500 kHz to 3 MHz, is specified and a piezoelectric element having an approximately suitable thickness for obtaining a thickness resonance vibration is provided. A cover plate is provided and the thickness of the cover plate is then varied until a thickness resonant vibration of the system of piezoelectric element and cover plate is obtained at the selected operating frequency.

Moreover, the description of the objects disclosed herein is not limited to the individual specific embodiments. Rather, the features of the individual embodiments may be combined with each other, to the extent technically useful.

### BRIEF DESCRIPTION OF THE DRAWINGS

In the following, the subject matters described herein are described more detailed by means of schematic exemplary embodiments.

FIG. 1 shows an embodiment of an ultrasonic transducer in sectional view;

FIG. 2 shows an embodiment of an ultrasonic transducer in exploded view;

FIG. 3 shows an embodiment of an ultrasonic transducer in schematic diagram representation;

FIG. 4 shows an arrangement of a piezoelectric element and a cover plate in schematic sectional view;

FIG. 5 shows a use of an ultrasonic transducer for measuring the fill level of a liquid container in a schematic diagram view;

FIGS. 6A to 6C show an embodiment of an arrangement of an ultrasonic transducer and a container in a side view, a side detailed view and a view on a bottom side;

FIG. 7 shows a further embodiment of an arrangement of an ultrasonic transducer and a container in a side view;

FIG. 8 shows a further embodiment of an arrangement of an ultrasonic transducer and a container in a side view; and

FIGS. 9A and 9B show a further embodiment of an arrangement of an ultrasonic transducer and a container in a lateral view and a view on a bottom side.

Preferably, in the figures, the same reference signs refer to functionally or structurally corresponding parts of the various embodiments.

### DETAILED DESCRIPTION OF ILLUSTRATIVE EMBODIMENTS

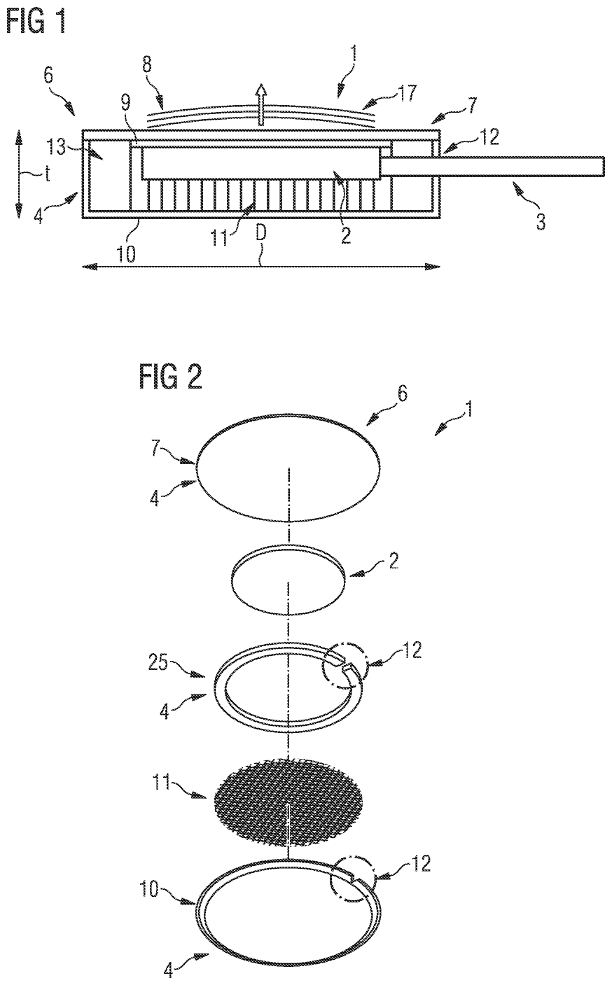

FIG. 1 shows an embodiment of an ultrasonic transducer 1 in a sectional view. The ultrasonic transducer 1 comprises a piezoelectric element 2 for generating ultrasonic waves from an electrical signal and/or for generating an electrical signal from received ultrasonic waves. In particular, the piezoelectric element 2 is a piezoceramic element, for example a PZT ceramic. For example, the piezoelectric element 2 is in the form of a disk. It may also be a platelet with a different geometry.

The piezoelectric element 2 is connected to one or more connection leads 3. The connection leads 3 are connected to electrodes (not shown here), for example two flat electrodes arranged on opposite main sides of the piezoelectric element 2. When a voltage is applied between the electrodes, the piezoelectric element 2 can be made to vibrate to generate an acoustic wave in the ultrasonic range.

The piezoelectric element 2 is arranged in a housing 4. The housing 4 may be formed to be waterproof. For example, the housing 4 is configured to be disc-shaped towards the outside, in particular similar in geometry and size to a coin. Due to the small size of the ultrasonic unit 6, the ultrasonic transducer 1 can particularly well also be retroactively attached to a container.

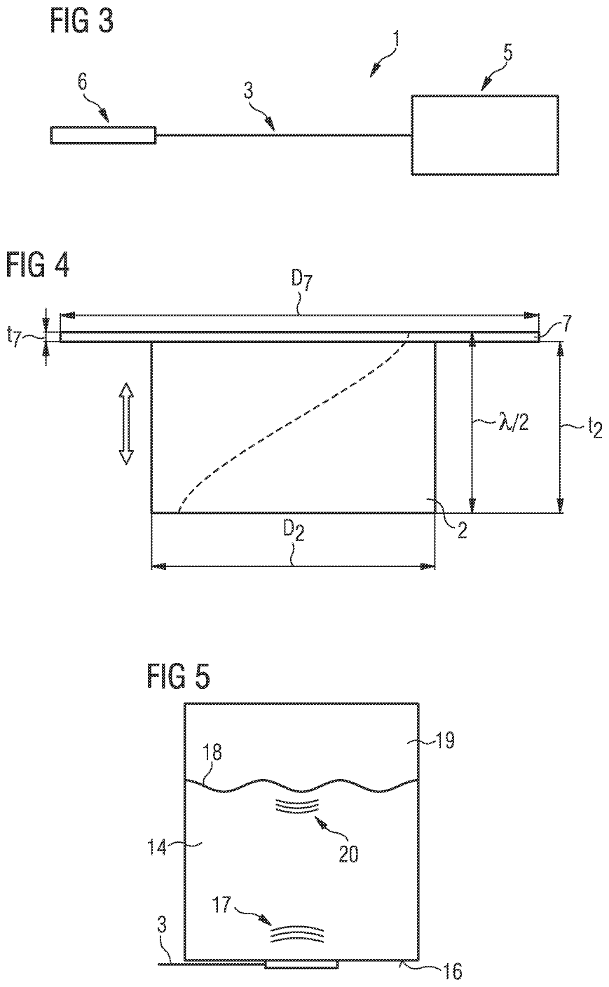

The connecting leads 3 are led through an opening 12 in the housing 4 and are configured to be connected to control and/or evaluation electronics 5 (FIG. 3). This may in particular be a compact electronic unit. In particular, it is an electronic control and/or evaluation unit. The control and/or evaluation electronics need not necessarily be configured as a compact unit, but can be flexibly selected by the user. Thus, the ultrasonic transducer 1 has an ultrasonic unit 6 with a small size that can be used flexibly.

The piezoelectric element 2 is attached to an underside of a cover plate 7 of the housing 4. The piezoelectric element 2 is attached to the cover plate 7 by means of an adhesive layer 9, for example. The adhesive layer 9 is formed as thin as possible to prevent interfering reflections. For example, the adhesive layer 9 has a thickness of 15 μm or less.

The cover plate 7 is configured as a steel plate, for example. The cover plate 7 can also be formed from another material. In particular, the cover plate 7 can adapt an acoustic impedance that is as close as possible to the acoustic impedance of the piezoelectric element 2. In this way, undesirable reflections at the interface with the cover plate 7 can be avoided and the cover plate 7 emits the acoustic vibration of the piezoelectric element 2 to the outside as unchanged as possible.

The vibration of the piezoelectric element 2 thus does not serve to generate a membrane-like mechanical vibration of the cover plate 7, i.e., for example, a vibration of a string with firmly clamped edge areas, but is directly the acoustic signal to be emitted to the outside. In particular, an acoustic vibration is generated in the form of a plane wave which is transmitted into the liquid via the cover plate.

The diameters of the cover plate 7 and the piezoelectric element 2 can thus be configure similarly, since the cover plate 7 does not have to be configured for being enabled to mechanically vibrate as a membrane, and the piezoelectric element 2 thus does not have to permit mechanical, membrane-like vibration of the cover plate 7.

For example, the acoustic impedance of the piezoelectric element 2 is 35 MRayl and the acoustic impedance of a steel cover plate is 45 MRayl.

The cover plate 7 forms the emission side 8 of the ultrasonic unit 6, and acoustic waves 17 are radiated from or received by the emission side 8. In particular, the cover plate 7 is part of the housing 4 and is bonded to the other housing parts, for example. The cover plate 7 serves to protect and support the piezoelectric element 2.

Between a bottom side of the piezoelectric element 2 and a bottom side of the housing 4, a rear structure (so-called “air-backing”) 11 is arranged. The air-backing structure serves to increase the robustness of the arrangement and should influence the vibration of the piezoelectric element 2 as little as possible. The structure 11 may also be configured to increase the bandwidth of the transducer, for example for uses where a sharp pulse is required.

One or more additional elements 13 may be arranged in lateral edge regions of the housing 4, for example for mechanical amplification of the ultrasonic unit 6 or also for electrical adaptation of the ultrasonic unit 6 to the signal source and the connecting lead 3. For example, additional elements 13 may be used to reduce the distortion time or to increase the bandwidth for pulse excitation. For example, an additional element 13 may be a leakage resistor and/or a structure for electrical matching. For example, the structures may be arranged in a printed circuit board (PCB) to which the connecting lead 3 is connected. The additional element 13 may also be a side part of the housing 4 or a printed circuit board.

FIG. 2 shows an embodiment of an ultrasonic unit 6 of an ultrasonic transducer 1 in exploded view. The ultrasonic unit 6 is configured essentially like the ultrasonic unit 6 shown in FIG. 1.

The housing 4 comprises the cover plate 7, a side part 25 and a bottom side 10. In particular, the housing 4 may of these three components. Additionally, the housing 4 may be sealed with an insulating material.

The opening 12 extends through a bottom side 10 of the housing 4 and through an annular side part 25 of the housing 4. On the one hand, the side part 25 serves as a spacer between the bottom side 10 and the cover plate 7. Furthermore, the side part 25 can also be formed as a printed circuit board (“PCB”), in which additional elements for adapting the piezoelectric element 2 to the connecting leads 3 and the electronics 5 are integrated.

To manufacture the ultrasonic unit 6, the cover plate 7 can, for example, be cut out of a foil, in particular a steel foil. This enables manufacturing with a tighter tolerance (±3 μm) than in the case of fabrication. The foil and the cover plate 7 produced from it have a thickness of 200 μm or less, for example. In particular, the thickness may be 100 μm or less. For example, a thickness of 50 μm can still be easily manufactured. Such a small thickness enables reliable adjustment of the resonance frequency and reduces the influence of the cover plate 7 on the properties of the ultrasonic unit 6.

Subsequently, the piezoelectric element 2 is fastened to the cover plate 7 by adhesive bonding. For example, the piezoelectric element 2 has a thickness of 900 μm. The adhesive layer 9 is made as thin as possible. For example, the adhesive layer 9 has a thickness of 15 μm or less so that it affects the properties of the ultrasonic unit 6 as little as possible.

Subsequently, the annular side part 25 is fastened, for example glued, to the cover plate 7. The annular side part 25 can be a metal part or also a printed circuit board. The connecting lead 3 is attached to the piezoelectric element 2 or to the circuit board, for example by soldering. The printed circuit board has a thickness of 150 μm, for example. The piezoelectric element 2 has, for example, a sputtered silver layer on one side for attaching the connecting lead 3.

Finally, the rear structure 11 is placed and the housing 4 is closed to the outside by fastening a bottom side 10, in particular a bottom plate. The back-side structure 11 is formed, for example, as a perforated polymer or metal plate, for example in a thickness of 200 μm. The back-side structure 11 serves primarily to mechanically stabilize 6 the ultrasonic unit and should have as low an acoustic impedance as possible, in particular an impedance similar to air (“air-backing”). The bottom side 10 is formed, for example, as a plate with a thickness of 300 μm. The housing 4 may have the overall shape of a flat button battery cell. Additionally, for preventing short circuits, insulation is provided, for example.

For example, the entire housing 4 has an outer thickness t of 1.5 mm and a diameter D of 20 mm. The thickness of the housing 4 corresponds to the overall thickness of the ultrasonic unit 6. The resonant frequency used for operation is, for example, 2 MHz.

The ultrasonic transducer 1 is manufactured, for example, in the form of the ultrasonic unit 6 and the connecting lead 3 connected thereto. The electronics 5 can then be provided by the customer and connected to the c connecting lead 3 in a simple manner. Thus, the electrical connection of the ultrasonic unit 6 is well defined, for example, by a connecting lead 3 in the form of a coaxial cable or a flexi-cable, and deterioration of the operating characteristics due to electrical parasitic influences are prevented.

As shown in a diagram representation in FIG. 3, the control and/or evaluation electronics 5, for example in the form of an electronics unit, can be provided separately from the housing 4. The length of the connecting lead 3 can be selected flexibly, for example in a length of 0.1 m to 2 m, so that the ultrasonic transducer 1 can be arranged spatially separated from the electronics 5. In particular, the connecting lead can have a length of at least 0.5 m. The connecting lead 3 can, for example, be a coaxial cable or a flexible printed circuit board.

Thus, the ultrasonic transducer 1 can be flexibly arranged at a measuring position, in particular in a confined space. The electronics 5 can also be flexibly positioned, in particular at a location easily accessible to a user.

Such an ultrasonic unit 1 is inexpensive to manufacture, so that even if there are a large number of containers to be measured, each container can be equipped with the ultrasonic unit 1. The electronics 5 can then be connected and disconnected as required.

FIG. 4 shows in a schematic sectional view an exemplary thickness ratio of the piezoelectric element 2 and the cover plate 7, for example in an ultrasonic unit 6 of an ultrasonic transducer 1 of FIGS. 1 to 3.

The piezoelectric element 2 has, for example, a thickness t2 of 0.9 mm. The diameter D2 is, for example, 15 mm. The cover plate 7 has, for example, a thickness t7 of 0.1 mm. The diameter D7 is 20 mm, for example. The adhesive layer 9 is neglected here. The diameters are not reproduced here to scale.

In the present case, the piezoelectric element 2 is configured to operate in a thickness oscillation mode of the system comprising the piezoelectric element 2 and the cover plate 7, in particular at a thickness resonance frequency. Thus, the expansion of the piezoelectric element 2 in the thickness direction, i.e. shown here in the vertical direction, is utilized when an electric voltage with field strength parallel to the thickness direction (d33 effect) is applied. An acoustic plane wave is generated in the piezoelectric element 2 and the cover plate 7, which propagates perpendicular to the main surface of the cover plate 7.

With similar acoustic impedances of the cover plate 7 and piezoelectric element 2, the cover plate 7 acts as an extension of the piezoelectric element but without the piezoelectric properties. The thickness t7 of the cover plate 7 is thus used to fine-tune the final resonant frequency of the ultrasonic unit 6. In particular, a desired operating frequency, for example of 2 MHz may be specified. The total thickness of piezoelectric element 2 and cover plate 7 is then selected so that the thickness vibration is in resonance. In this case, the ultrasonic unit is operated particularly efficiently, especially at a thickness resonance frequency.

For a homogeneous material, the following relationship between acoustic velocity v, frequency f and wavelength λ of the generated acoustic vibration can be derived: v=f*λ. For a composite structure of piezoelectric material of the piezoelectric element 2 and the material of the cover plate 7, the wavelength λ can be determined from an equivalent acoustic velocity of the whole system. For example, with an equivalent acoustic velocity v=4000 m/s in the overall system of piezoelectric element 2 and cover plate 7 at an operating frequency of 2 MHz, the wavelength is λ=4 mm. The total thickness of piezoelectric element 2 and cover plate 7 is thus λ/2=2 mm in the optimum case.

For example, at the selected thicknesses (piezoelectric element 0.9 mm; cover plate 0.1 mm), a resonant frequency is 2 MHz. When the thickness is increased, e.g. to a total thickness of 2 mm, the resonant frequency is, for example, 1 MHz.

To obtain the clearest possible resonance frequency, the ratio of the diameter D2 of the piezoelectric element 2 to its thickness t2 is chosen to be, for example, 10:1 or 15:1 or higher, for example 20:1. Thus, with a ratio of 15:1 for a thickness of 1 mmm, the diameter is, for example, 15 mm, and with a thickness of 2 mm, the diameter is 30 mm.

The thickness of the cover plate 7 can be minimized. For example, the ratio of the thickness of the cover plate 7 to the thickness of the piezoelectric element is 1:5 or smaller. In the embodiment shown, the thickness is 1:9. In particular, the thickness can be 50 μm or even less, depending on the required robustness, in order to influence the piezoelectric properties of the ultrasonic transducer 1 as little as possible and to transmit the acoustic vibration to the outside with as little interference as possible. However, even with the selected thickness of 0.1 mm, the arrangement shows a clearly defined resonance frequency at 2 MHz. This is achieved in particular by the small thickness of the cover plate 7 and by compensating the thickness of the cover plate 7 by a corresponding reduction of the thickness of the piezoelectric element 2.

The resonance frequency of the ultrasonic unit 6 is not very susceptible to interference. In particular, the resonance frequency is not altered by a selected mounting method, especially in the case of forces acting on a lateral surface or on the underside of the ultrasonic unit 6. The acoustic signal is transmitted to the outside only originating from the surface of the ultrasonic unit 6, while the other sides are acoustically passive.

FIG. 5 shows uses of an ultrasonic transducer 1 for measuring a fill level of a liquid 14 in a container 15.

The ultrasonic unit 6 may be attached to an underside 16 of the container 15. For example, the ultrasonic unit 6 is attached to the container using an adhesive, which may also serve as an acoustic coupling material, or an adhesive tape. In particular, when an adhesive tape is used, an acoustic matching material, for example a gel, may be arranged between the ultrasonic unit 6 and the container 15 to improve the transmission of the acoustic vibration. The ultrasonic unit 6 converts an electrical signal into an acoustic signal 17 that travels upward through the fluid 14. In particular, the ultrasonic unit 6 is operated at a frequency corresponding to a thickness resonance frequency of the system of piezoelectric element 2 and cover plate 7. Depending on the geometry of the piezoelectric element 2 and the cover plate 7, the resonance frequency is, for example, between 500 kHz and 3 MHz.

At the interface 18 to the gas 19, for example air, located above the liquid 14, a part of the signal 17 is reflected. The reflected signal 20 travels back to the ultrasonic unit 6, where it is converted into an electrical signal. From the signal travel time and the acoustic velocity in the liquid 14, the liquid level, i.e. the position of the interface 18, can be determined. The electronics for control and evaluation 5 are located in a place easily accessible to the user and are connected to the ultrasonic unit 6 by means of the connecting lead 3.

As an alternative to arranging the ultrasonic unit 6 outside the container 15, it is also possible to arrange the ultrasonic unit 6 at the bottom inside the container 15, in particular in the liquid 14. For this purpose, the ultrasonic unit 6 is sealed in a liquid-tight manner.

When operated at a resonance frequency in the range around 1 MHZ, for example from 800 kHz to 3 MHz, the ultrasonic transducer is particularly suitable for operation in such a way that the acoustic signal 17 passes through the liquid 14 and is reflected at the interface 18 with the gas 19.

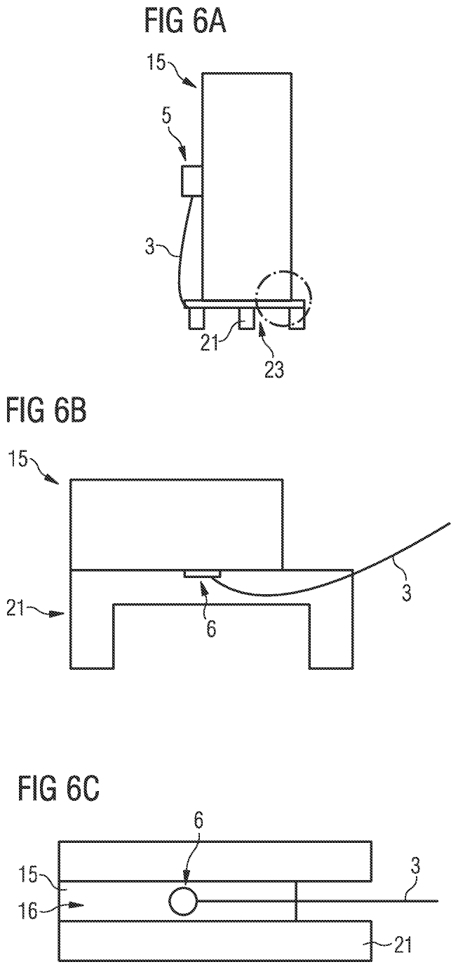

FIGS. 6A to 6C show an embodiment of an arrangement of an ultrasonic transducer 1 and a container 15. FIG. 6A shows the arrangement in a side view of the container 15. FIG. 6B shows a detailed view from FIG. 6A near the bottom of the container 15. FIG. 6C shows a detailed view looking at a bottom 16 of the container 15.

The container 15 is for example a barrel in a standard shape, for example with a volume of 210 liters. The container 15 is, for example, made of plastic. The container 15 is arranged on a support 23, in particular a pallet 21.

Due to the small dimensions of the ultrasonic unit 6 and the separation from the electronics 5, the ultrasonic unit 6 can be arranged on an underside of the container and thereby in narrowly limited space areas, for example small niches. As can be seen in FIG. 6D, the ultrasonic unit 6 is arranged between the boards of the pallet.

The connection lead 3 is configure thin so that it is guided through the gaps in the pallet 21 to the electronics 5. The electronics 5 is arranged on a side surface 22 of the container 15 and is thus easily accessible to the user.

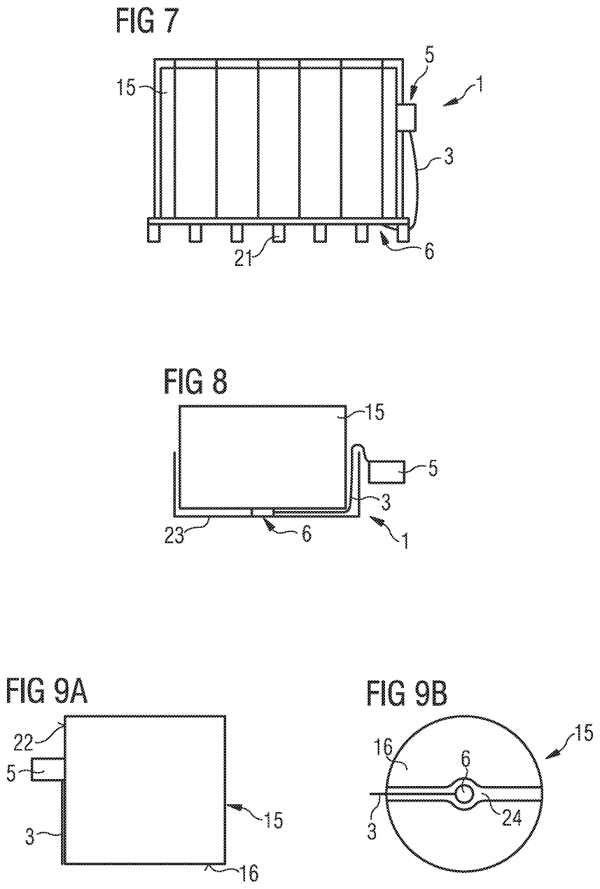

FIG. 7 shows a similar arrangement of an ultrasonic transducer 1 at a container 15, in this case a so-called IBC container (“Intermediate Bulk Container”). Such a container 15 is cuboidal in shape and has a volume of, for example, 500 to 3000 liters. The container 15 has a plastic wall and is surrounded by a metal profile frame. The container 15 is also arranged on a pallet 21.

FIG. 8 shows a further arrangement of an ultrasonic transducer 1 on a container 15. The container 15 is arranged on a support 23. The support 23 has, for example, a receptacle for the container 15. It can also simply be a plate. The ultrasonic unit 6 is arranged on the underside of the container 15 and is fixed in position only by the weight of the container 15. The connecting lead 3 is routed to an electronic unit 5 on the underside and side surface of the container 15.

This arrangement is well suited for smaller containers 15, for example containers with a few liters volume. When the container 15 is empty, it can be easily replaced with a full container, leaving the ultrasonic unit 6 on the support 23 during replacement.

FIGS. 9A and 9B show a further embodiment of an arrangement of an ultrasonic transducer 1 and a container 15, for example a commercial barrel in a standard shape, for example with a volume of 210 liters.

In this arrangement, the container 15 is not arranged on a support, but simply stands on a flat bottom. The container 15 has a recess 24 in its wall on its underside 16. The ultrasonic unit 6 is arranged in this recess, for example glued to the container 15. The recess 24 may be only a few millimeters deep, but this is sufficient to arrange the small ultrasonic unit 6 completely in the recess 24 so that the container 15 does not exert any weight force on the ultrasonic unit 6.

The connecting lead 3 is guided through the recess 24 along the underside 16 to a side surface 22 of the container 15 and connected to the electronics 5 mounted there.

When attaching the ultrasonic unit 6 to the container 15, the acoustic coupling between the emitter side of the ultrasonic unit 6 and the surface of the container 15 can be optimized by using a gel, adhesive or polymer mat with good acoustic coupling.

Although the invention has been illustrated and described in detail by means of the preferred embodiment examples, the present invention is not restricted by the disclosed examples and other variations may be derived by the skilled person without exceeding the scope of protection of the invention.

1-21. (canceled)

22. An ultrasonic transducer comprising:
an ultrasonic unit with a housing in which a piezoelectric element is located,
wherein the ultrasonic unit comprises at least one electrical connecting lead leading out of the housing, the connecting lead being configured for connection to control and/or evaluation electronics arranged separately from the ultrasonic unit, and
wherein the ultrasonic unit is configured to operate in a thickness oscillation mode.

23. The ultrasonic transducer according to claim 22, wherein the piezoelectric element is fastened to a cover plate of the housing and the ultrasonic unit is configured for operation in the thickness oscillation mode in resonance of a system of the piezoelectric element and the cover plate.

24. The ultrasonic transducer according to claim 22, wherein the housing comprises a cover plate, wherein the piezoelectric element is fastened to the cover plate, and wherein the connecting lead is led laterally out of the housing.

25. The ultrasonic transducer according to claim 22, wherein the housing has a disc-shaped outer geometry.

26. The ultrasonic transducer according to claim 22, wherein the ultrasonic unit is at most twice as thick as the piezoelectric element.

27. The ultrasonic transducer according to claim 22, wherein the connecting lead is a coaxial cable.

28. The ultrasonic transducer according to claim 22, wherein the piezoelectric element is fastened to a cover plate of the housing, which is configured to conduct a thickness vibration of the piezoelectric element to an outside.

29. The ultrasonic transducer according to claim 22, wherein the housing comprises a cover plate, and wherein the cover plate is a steel plate.

30. The ultrasonic transducer according to claim 22, wherein the housing comprises a cover plate, wherein a thickness of the piezoelectric element and a thickness of the cover plate are such that they are configured to generate a vibration in a thickness-resonance at a specified operating frequency in a range of 500 kHz to 3 MHz.

31. The ultrasonic transducer according to claim 22, wherein the housing comprises a cover plate, and wherein a thickness of the piezoelectric element is greater than a thickness of the cover plate.

32. The ultrasonic transducer according to claim 22, wherein the ultrasonic unit has a thickness of at most 5 mm and a diameter of at most 5 cm.

33. A method for operating the ultrasonic transducer according to claim 22, the method comprising:
measuring a level of a liquid in a container.

34. An arrangement comprising:
the ultrasonic transducer according to claim 22; and
a container,
wherein the ultrasonic unit is arranged on an underside of the container.

35. The arrangement according to claim 34, wherein the control and/or evaluation electronics are connected to the connecting lead, and wherein the control and/or evaluation electronics are a compact electronics unit and are arranged on a side surface of the container.

36. The arrangement according to claim 34, wherein the ultrasonic unit is fastened to the container by an adhesive or an adhesive tape.

37. The arrangement according to claim 34, wherein the ultrasonic unit is fixed in a position solely by a weight of the container.

38. A method for operating the ultrasonic transducer according to claim 22, the method comprising:
operating the ultrasonic transducer in the thickness oscillation mode.

39. The method according to claim 38, wherein the piezoelectric element is fastened to a cover plate of the housing, and wherein the ultrasonic transducer is operated in resonance of a system of the piezoelectric element and the cover plate.

40. The method according to claim 38, wherein the ultrasonic transducer is operated at a frequency in a range of 500 kHz to 3 MHz.

41. method for manufacturing an ultrasonic unit, the method comprising:
specifying an operating frequency;
providing a piezoelectric element with a thickness for operating in a thickness vibration mode;
fastening the piezoelectric element to a cover plate; and
varying a thickness of the cover plate until the thickness vibration in resonance is obtained at the specified operating frequency.

42. The method according to claim 41, wherein the thickness of the cover plate is varied until a thickness vibration in resonance of a system of the piezoelectric element and the cover plate is obtained at the specified operating frequency.
